(19) United States
(12) Patent Application Publication
(10) Pub. No.: US 2018/0370095 A1
(43) Pub. Date: Dec. 27, 2018

(54) APPARATUS AND METHOD FOR MANUFACTURING INTEGRAL EMBLEM

(71) Applicants: Hyundai Motor Company, Seoul (KR); Kia Motors Corporation, Seoul (KR)

(72) Inventor: Min Ho CHOI, Seoul (KR)

(73) Assignees: Hyundai Motor Company, Seoul (KR); Kia Motors Corporation, Seoul (KR)

(21) Appl. No.: 15/797,958

(22) Filed: Oct. 30, 2017

(30) Foreign Application Priority Data
Jun. 21, 2017 (KR) 10-2017-0078336

(51) Int. Cl. B29C 45/14

(52) U.S. Cl. CPC B29C 45/14065; B29C 45/14016; B29L 2031/30; B29C 2045/14713; B29C 45/14688

(57) ABSTRACT

An apparatus for manufacturing an integral emblem, may include a mold including a first mold and a second mold and formed to have a cavity formed therein when the mold is closed; an In-Mold Decoration (IMD) film supplier disposed to the first mold and configured for supplying an IMD film; a position detector disposed in the mold and configured for detecting a position of the IMD film; and an injection material injector disposed on a rear of the second mold and combined with a fluid path in the second mold when the mold is closed.

### CROSS-REFERENCE(S) TO RELATED APPLICATIONS

the present application claims priority to Korean Patent Application No. 10-2017-0078336, filed on Jun. 21, 2017, the entire contents of which is incorporated herein for all purposes by this reference.

### BACKGROUND OF THE INVENTION

### Field of the Invention

The present invention relates to an apparatus and method for manufacturing an integral emblem, and, more particularly, to an apparatus and method for injection molding of an integral vehicle emblem by an injection molder provided with a film supplier to continuously supply In-Mold Decoration (IMD) films.

### Description of Related Art

In general, an emblem is a representation of an image of a company or an organization, which is formed in a figure, a letter, a symbol, or a combination thereof. An emblem of a product manufacturing company is attached onto a surface of a product manufactured by the company and used for advertising the manufacturing company or the product. Vehicle emblems are attached onto external and/or internal portions of a vehicle, including an airbag, a hood top, a wheel cap, a side trim, a gear knob, etc., to represent the manufacturing company.

FIG. 1 shows a perspective view and an enlarged cross-sectional view of a conventional wheel cap with an emblem.

Referring to FIG. 1, a thin plate 2-1′ of aluminum is press-formed into a shape, e.g., a circular shape, washed, dried, and then partially painted with an emblem or logo 2-2′ by a masking jig. Subsequently, the logo 2-2′ is clear-coated 30′ to protect and give a gloss to the dried paint film, to secure weather resistance and chipping resistance.

Apart from the above, a plastic injected article 10′ needs to be separately manufactured for the emblem or logo to be attached onto the internal and/or external portions of the vehicle. The thin plate of aluminum 2-1′ with the emblem or logo 2-2′ marked thereon and the plastic injected article 10′ are combined into a complete product by a double-sided tape or an adhesive.

The present manufacturing method has many processes, which makes manufacturing complicated and increased risk of quality problems during the processes. Especially, the thin plate of aluminum and the plastic injected article include different materials, so when the adhesive force is weak, they may be exfoliated or separated and the back surface of the thin plate of aluminum has a white color rust from erosion.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a manufacturing apparatus and method, by which an integral emblem to be attached onto vehicle members is injection molded by attaching an In-Mold Decoration (IMD) film supplier to an injection molder.

An apparatus for manufacturing an integral emblem in accordance with various exemplary embodiments of the present invention may include a mold having a first mold and a second mold and having a cavity formed therein when closed; an IMD film supplier disposed to the first mold for supplying the IMD film; a position detector disposed in the mold and configured for detecting a position of the IMD film; and an injection material injector disposed on a rear surface of the second mold and combined with a fluid path of the second mold when the mold is closed.

Furthermore, according to an exemplary embodiment of the present invention, the mold may include a plurality of cavities.

Furthermore, according to an exemplary embodiment of the present invention, the IMD film may have at least three or more reference points detectable by the position detector.

Furthermore, according to an exemplary embodiment of the present invention, the position detector may include a camera detector, which is disposed on the first mold.

Furthermore, according to an exemplary embodiment of the present invention, the cavity may have a first internal surface formed to be embossed or engraved.

Furthermore, according to an exemplary embodiment of the present invention, the apparatus may further include a cooler configured to harden the injected injection material.

A method for manufacturing an integral emblem in accordance with various exemplary embodiments of the present invention may include preparing an IMD film with a reference point marked thereon; supplying the IMD film into a cavity of the mold; detecting the reference point by the position detector; injecting a melted injection material into the cavity; and hardening the injection material.

Furthermore, according to an exemplary embodiment of the present invention, at least three or more reference points may be marked at corners of the IMD film.

Furthermore, according to an exemplary embodiment of the present invention, detecting the reference point by the position detector may include detecting the reference point by a camera detector, and performing a fine tuning to position the IMD film in the cavity.

Furthermore, according to an exemplary embodiment of the present invention, the injection material may include one or more selected from a group consisting of acrylonitrile-butadiene-styrene (ABS), polycarbonate/acrylonitrile-butadiene-styrene (PC/ABS), modified polyphenylene oxide (mPPO), poly(methylmethacrylate) (PMMA), polyamide (PA), and polyphenylene ether (PPE).

Furthermore, according to an exemplary embodiment of the present invention, after hardening the injection material, the method may further include clear-coating a surface of the IMD film.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A shows a perspective view of a wheel cap with an emblem according to the related art;

FIG. 1B shows an enlarged cross-sectional view of a wheel cap with an emblem according to the related art;

FIG. 2 is a cross-sectional view of an In-Mold Decoration (IMD) film according to an exemplary embodiment of the present invention;

FIG. 3 is a cross-sectional view of an apparatus for manufacturing an integral emblem according to an exemplary embodiment of the present invention;

FIG. 4A shows a perspective view of an integral emblem according to an exemplary embodiment of the present invention;

FIG. 4B shows an enlarged cross-sectional view of an integral emblem according to an exemplary embodiments of the present invention; and

FIG. 5 is a flowchart schematically illustrating a method for manufacturing an integral emblem according to an exemplary embodiment of the present invention.

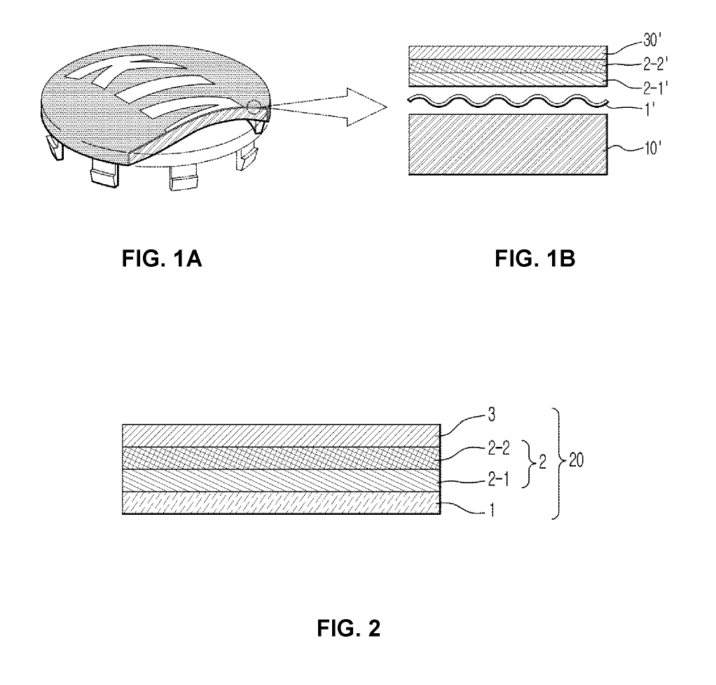

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims

Not all elements of exemplary embodiments of the present invention will be described, and description of what are commonly known in the art or what overlap each other in the exemplary embodiments will be omitted.

The term “include (or including)” or “comprise (or comprising)” is inclusive or open-ended and does not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

Various aspects of the present invention are directed to providing an apparatus and method for manufacturing an integral emblem. An emblem is a representation of an image of a company or organization, which is formed in a figure, a letter, a symbol, or a combination thereof, and includes a logo. An integral emblem in accordance with various exemplary embodiments of the present invention refers to an emblem to be disposed to internal and/or external portions provided in a vehicle, which will be described by taking an example of one of wheel caps disposed to four wheels of any kind of vehicle. The scope of the present invention is not, however, limited to the emblem attached to the wheel cap, but encompasses any emblem to be attached to any internal and/or external portions of the vehicle.

FIG. 2 is a cross-sectional view of an In-Mold Decoration (IMD) film used in a manufacturing apparatus 100, according to an exemplary embodiment of the present invention. First, referring to FIG. 2, an IMD film 20 used in a manufacturing apparatus and method in accordance with various exemplary embodiments of the present invention will now be described.

IMD is a technology to transfer a printed pattern onto a surface of e.g., a plastic product or a ceramic product in a mold at the same time as injection molding, by inserting a film laminated with the printed pattern in the mold during the injection molding of the plastic product or the ceramic product, and an IMD film is a film used in the IMD method. The IMD film is widely used for decoration and protection of a case of the smart phone, laptop personal computer (PC), and/or digital camera, a case of a plurality of home appliances, a container of cosmetics, and/or a surface of vehicle members.

The IMD film 20 may include an adhesive layer 1, a printed layer 2, and a cover layer 3.

In an apparatus and method for manufacturing an integral emblem, which will be described later, the adhesive layer 1 may increase an adhesive force between an injection material and the printed layer 2, with the IMD film 20 placed in a first mold 41 when a melted injection material is injected into a closed mold 40,

The printed layer 2 is formed on the adhesive layer 1, and may include a silver printed layer 2-1 corresponding to a thin film of aluminum 2-1′ and a black printed layer 2-2 corresponding to a partial paint 2-2′. The silver printed layer 2-1 may include silver ink and thinner, the silver ink including e.g., chromium (Cr). The black printed layer 2-2 may include black ink and thinner.

The cover layer 3 may be formed on the printed layer 2, and may be an elastic and flexible film of resin. For example, the cover layer 3 may be a polyethylene terephthalate (PET) resin.

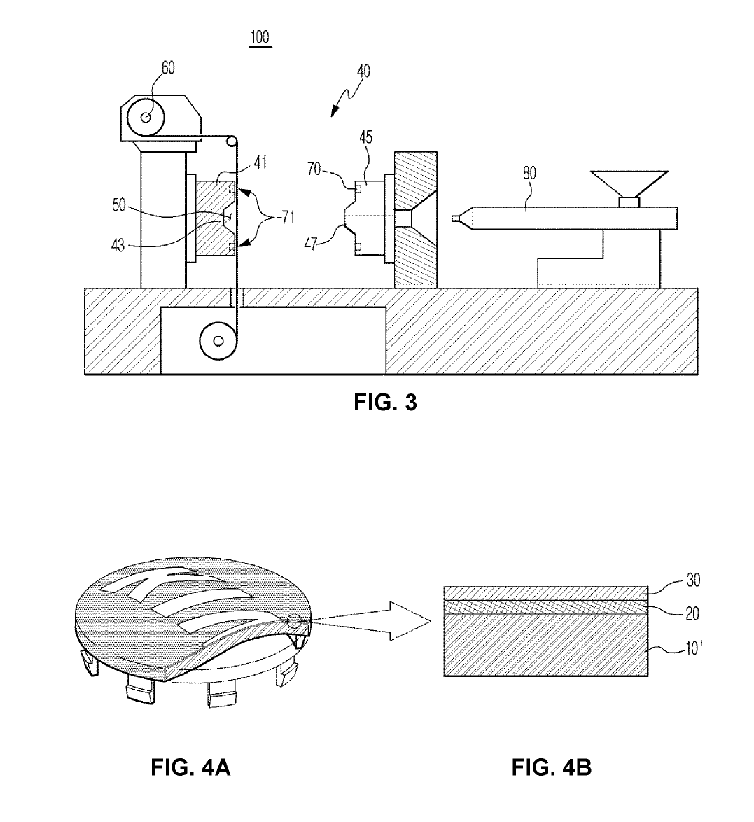

FIG. 3 is a cross-sectional view of an apparatus for manufacturing an integral emblem, according to an exemplary embodiment of the present invention.

Referring to FIG. 3, an apparatus 100 for manufacturing an integral emblem in accordance with various exemplary embodiments of the present invention includes the mold 40 having the first mold 41 and a second mold 45 and having a cavity 50 formed therein when closed; an IMD film supplier 60 disposed to the first mold 41 for supplying the IMD film 20; a position detector 70 disposed in the mold 40 and configured for detecting a position of the IMD film 20; and an injection material injector 80 disposed on a rear surface of the second mold 45 and combined with a fluid path of the second mold 45 when the mold 40 is closed.

The mold 40 includes the first mold 41 and the second mold 45. The first and second molds 41 and 45 are movable between a closed position where the first and second molds 41 and 45 closely contact each other and an open position where the first and second molds 41 and 45 are separated from each other. In general, the second mold 45 is moved between the closed position and the open position by moving close to the first mold 41 or away from the first mold 41 while the first mold 41 remains fixed, but the opposite case may be possible.

When the first and second molds 41 and 45 are closed, they may form the cavity 50, a closed region corresponding to an integral emblem injected article in accordance with various aspects of the present invention. The cavity 50 may have a shape defined wherein a first internal surface 43 of the cavity 50 corresponds to a top surface of the integral emblem injected article and a second internal surface 47 corresponds to a bottom surface of the integral emblem injected article.

Although the mold 40 is shown to have a single cavity 50 formed therein, the mold 40 of the manufacturing apparatus 100 may be formed to have a plurality of cavities 50. For example, there may be two or more cavities 50 to increase productivity. In the present case, the IMD film supplier 60, which will be described later, may supply the IMD film 20 printed with an emblem to correspond to the plurality of cavities 50.

The IMD film 20 may be successively supplied where the cavities 50 are positioned in the mold 40 by the IMD film suppler 60.

The IMD film supplier 60 may be disposed to the first mold 41 and may supply a roll or sheet of the IMD film 20 wound around the IMD film supplier 60 into the mold 40. In this regard, the IMD film 20 is supplied for the cover layer 3 of the IMD film 20 to face the first internal surface 43 of the cavity 50. The IMD film supplier 60 may automatically supply the IMD film 20 according to opening or closing of the mold 40. For example, when the mold 40 is opened after being injection molded, the IMD film supplier 60 may automatically supply the IMD film 20.

In an exemplary embodiment of the present invention, the first internal surface 43 of the cavity 50 may be embossed or engraved. As the shape of an emblem or logo is embossed or engraved on the first internal surface 43 of the cavity 50, the manufactured emblem or logo of an injection molded product may be expressed in intaglio or relief. In other words, in a case that the emblem is embossed on the first internal surface 43 of the cavity 50, the emblem is expressed in intaglio, which has a form which is concave inward from the top surface of the injection molded product, and in a case that the emblem is engraved on the first internal surface 43 of the cavity 50, the emblem is expressed in relief, which has a form which is swollen from the top surface of the injection molded product due to an injection pressure.

In comparison with the conventional process of the thin film of aluminum 2-1′, preparing the first internal surface 43 of the cavity 50 to be embossed or engraved according to the shape of the emblem printed on the IMD film 20 may facilitate three dimensional embodiment of the emblem or logo.

The IMD film 20 to be supplied into the mold 40 needs to be supplied for the position of the emblem or logo to correctly correspond to the cavity 50. When the emblem of the IMD film 20 is supplied e.g., not right in middle center of the cavity 50 of a round shape, the integral emblem, a manufactured injection molded product may be one-sided toward one of up, down, left or right.

The apparatus 100 for manufacturing an integral emblem includes the position detector 70 disposed in the mold 40 and configured to detect a position of the IMD film 20. The position detector 70 may detect whether the position of the IMD film 20 corresponds to a requested position in the cavity 50. When the position of the IMD film 20 does not correspond to the requested position in the cavity 50, the IMD film supplier 60 may include a film position adjuster for fine tuning the position of the IMD film 20.

The position detector 70 may be disposed on the first mold 41 or the second mold 45. In a case that the position detector 70 is disposed on the first mold 41 or the second mold 45, the positioned detector 70 may be placed on an internal surface of the mold 40, which is shown when the mold 40 is opened, to detect the position of the successively supplied IMD film 20. Alternatively, the position detector 70 may be disposed on a side of the first mold 41 or second mold 45.

For fine tuning, the IMD film 20 may include a reference point 71 which is detectable by the position detector 70. The reference point 71 may be formed external to the emblem or logo printed on the IMD film 20, and there may be at least three or more reference points. When there are two or less reference points 71, just two dimensional inclining of the IMD film 20 may be detected, thus it is desirable to mark three or more reference points 71. For example, in a case that the mold 40 has a rectangular shape, four reference points may be marked.

The position detector 70 detecting the reference point 71 may include a camera detector. The camera detector may be disposed on the first mold 41 or the second mold 45 for detecting the reference point 71 marked on the supplied IMD film 20. When the reference point 71 detected by the camera detector is not a correct position, the mold 40 is closed after fine tuning of the position.

Through the adjustment of the position of the IMD film 20 by the position detector 70, the integral emblem, which is injection molded by the manufacturing apparatus 100 in accordance with various aspects of the present invention, may be manufactured to be right in the center or in a desired position.

An injection material injector 80 may be disposed on the rear of the second mold 45, and combined with an injection material fluid path provided in the second mold 45 when the mold 40 is closed. The injection material injector 80 injects the injection material into the cavity 50 through the injection material fluid path to fill the cavity 50, once the IMD film 20 is supplied and fine tuning is completed by the position detector 70, the mold 40 is closed and the injection material injector 80 may be moved to be combined with a combiner on the rear of the second mold 45 when the mold 40 is closed, and may discharge the injection material into the cavity 50 through the injection material fluid path.

In an exemplary embodiment of the present invention, the apparatus 100 for manufacturing an integral emblem may further include a cooler to harden the injected injection material. The cooler may harden the injection material injected into the cavity 50 by cooling the closed mold 40.

FIG. 4 shows a perspective view and an enlarged cross-sectional view of an integral emblem, according to an exemplary embodiment of the present invention.

Referring to FIG. 4, an integral emblem manufactured by the manufacturing apparatus 100 in an exemplary embodiment of the present invention is integrally formed with the injected article 10′ by replacing the conventional thin film of aluminum 2-1′ and partial paint 2-2′ with the IMD film 20. A melted injection material with a high temperature is combined with the adhesive layer 1 on a rear surface of the IMD film 20 not only chemically but also physically by the injection pressure of the injection material discharged by the injection material injector 80, solving the problem of exfoliation or separation.

Furthermore, the integral emblem may further include a clear coating layer 30 on the top surface of the IMD film 20 to improve weather resistance and chipping resistance.

Next, a method for manufacturing an integral emblem in accordance with various exemplary embodiments of the present invention will be described.

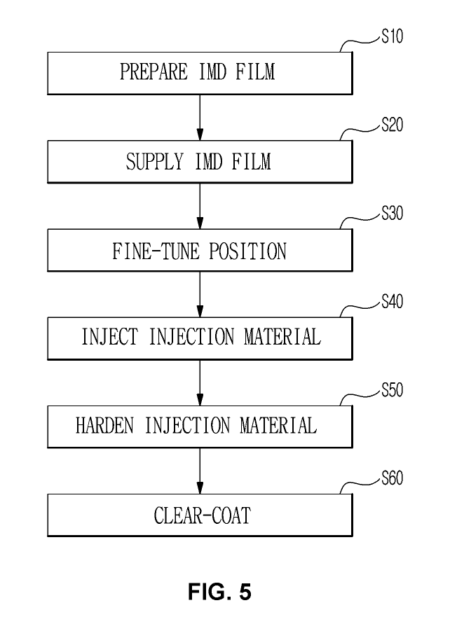

FIG. 5 is a flowchart schematically illustrating a method for manufacturing an integral emblem, according to an exemplary embodiment of the present invention.

The method may include preparing an IMD film with a reference point marked thereon (S10); supplying the IMD film into a cavity of a mold (S20); detecting the reference point by a position detector (S30); injecting a melted injection material into the cavity (S40); and hardening the injection material (S50).

The operation of preparing an IMD film with a reference point marked thereon (S10) includes preparing an IMD film, e.g., the IMD film 20 printed with an emblem (see FIG. 2). As described above, the IMD film 20 may have the printed layer 2 printed with an emblem, and the reference point 71 detectable by the position detector 70 may be marked at corners around the emblem.

The corners at which the reference points 71 are marked refer to other areas than an area corresponding to a top surface of a final injection molded product of the IMD film 20. There may be at least three or more reference points 71 marked to detect the correct position of the IMD film 20, and preferably, there may be four or more reference points 71 marked.

The operation of supplying the IMD film into a cavity of a mold (S20) includes supplying the IMD film 20 by the IMD film supplier 60 wherein a surface on which the cavity 60 of the opened first mold 41 is formed and the cover layer 3 of the IMD film 20 face each other. The IMD film supplier 60 may successively supply the IMD film 20, and automatically supply the IMD film 20 once the mold 40 is opened after injection molding.

The operation of detecting the reference point by the position detector (S30) includes detecting the reference point 71 by the position detector 70 to position the emblem printed on the supplied IMD film 20 right in the center of the cavity 50. The position detector 70 may be a camera detector, and when the camera detector detects that the reference point 71 is not correctly positioned, fine tuning may be performed. When the reference point 71 is at a correct position or fine-tuned, the mold 40 is closed.

The operation of injecting a melted injection material into the cavity (S40) includes injecting an injection material into the cavity 50 formed in the closed mold 40 by the injection material injector 80. The injection material injector 80 is moved to be combined with a combiner for injection material injector disposed on the rear surface of the second mold 45, and after the injection material injector 80 is combined with the combiner, the injection material is discharged into the cavity 50 through the injection material fluid path formed in the second mold 45. The inlet of the injection material fluid path is connected to the combiner for injection material injector, and the outlet of the injection material fluid path is connected to a point in the center of the second internal surface 47 of the cavity 50.

The injection material may include a thermoplastic resin, and include one or more selected from a group consisting of acrylonitrile-butadiene-styrene (ABS), polycarbonate/acrylonitrile-butadiene-styrene (PC/ABS), modified polyphenylene oxide (mPPO), poly(methylmethacrylate)) (PMMA), polyamide (PA), and polyphenylene ether (PPE). An ABS based injection material has a good adhesion property, especially for the IMD film 20.

The operation of hardening the injection material (S50) includes forming a final injection molded product, i.e., an integral emblem, by cooling the closed mold 40 to harden the melted injection material injected into the cavity 50. A solid integral emblem may be formed by the physical and chemical combination between the adhesive layer 1 of the IMD film 20 and the injection material. To cool the closed mold 40, the aforementioned cooler may be used for rapid cooling. Once the hardening is completed, the final injection molded product, i.e., the integral emblem, may be removed by opening the first and second molds 41 and 45.

In addition, an exemplary embodiment of the present invention may further include clear-coating the surface of the IMD film (S60), after hardening the injection material (S50).

The integral emblem removed has the top surface formed of the IMD film 20, requiring increased weather resistance and chipping resistance for the emblem to be attached to and used in a vehicle, and for the present regard, clear coating may be performed. A clear coating paint may be a polyurethane-based paint including an ultraviolet (UV) stabilizer.

In the meantime, as described above, the first internal surface 43 of the cavity 50 may be embossed or engraved. As the shape of an emblem or logo is embossed or engraved on the first internal surface 43 of the cavity 50, the manufactured emblem or logo of an injection molded product may be expressed in intaglio or relief. In other words, in a case that the emblem is embossed on the first internal surface 43 of the cavity 50, the emblem may be expressed in intaglio, which has a form which is concave inward from the top surface of the injection molded product, and in a case that the emblem is engraved on the first internal surface 43 of the cavity 50, the emblem is expressed in relief, which has a form which is swollen from the top surface of the injection molded product due to the injection pressure.

It is possible to express a three dimensional emblem by applying the IMD method only, and it is also possible to embody various expressions even by a combination with an INS method or a combination with a metal-coated injected article. The INS method refers to a method to press-form a film in advance to transform the film to be embossed or engraved, and perform injection molding on the transformed result. It is possible to produce combinations of emblems in various colors and various three dimensional figures by combining a three dimensional injected article resulting from the INS method and an injected article resulting from the IMD method of the present invention.

Exemplary embodiments of an apparatus and method for manufacturing an integral emblem are expected to have the following advantages of:

reducing the number of processes and thus securing cost competitiveness in comparison with the existing process of separately manufacturing and attaching a thin plate of aluminum and an injected article onto each other, improving the degree of freedom of a design by embodying an emblem or logo by use of a printed pattern of an IMD film, easily expressing a color and three dimensional effect of the emblem or logo, which had difficulty being processed on the existing thin film of aluminum, and solving a problem of rear surface erosion that may occur on the thin film of aluminum and a problem of exfoliation from the injected article.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for manufacturing an integral emblem, the apparatus comprising:
a mold including a first mold and a second mold and formed to have a cavity formed therein when the mold is closed;
an In-Mold Decoration (IMD) film supplier disposed to the first mold and configured for supplying an IMD film;
a position detector disposed in the mold and configured for detecting a position of the IMD film; and
an injection material injector disposed on a rear of the second mold and combined with a fluid path in the second mold when the mold is closed.

2. The apparatus of claim 1, wherein the mold includes a plurality of cavities.

3. The apparatus of claim 1, wherein the IMD film has at least three or more reference points detectable by the position detector.

4. The apparatus of claim 1, wherein the position detector includes a camera detector, which is disposed on the first mold.

5. The apparatus of claim 1, wherein the cavity has a first internal surface formed to be embossed or engraved.

6. The apparatus of claim 1, further including a cooler configured to harden the injected injection material.

7. A method for manufacturing an integral emblem, the method comprising:
preparing an In-Mold Decoration (IMD) film with a reference point marked thereon;
supplying the IMD film into a cavity in a mold;
detecting the reference point by a position detector;
injecting a melted injection material into the cavity; and
hardening the injection material.

8. The method of claim 7, wherein at least three or more reference points are marked at corners of the IMD film.

9. The method of claim 7, wherein detecting the reference point by the position detector includes:
detecting the reference point by a camera detector; and
perform fine tuning to place the IMD film in the cavity.

10. The method of claim 7, wherein the injection material includes one or more selected from a group consisting of acrylonitrile-butadiene-styrene (ABS), polycarbonate/acrylonitrile-butadiene-styrene (PC/ABS), modified polyphenylene oxide (mPPO), poly(methylmethacrylate)) (PMMA), polyamide (PA), and polyphenylene ether (PPE).

11. The method of claim 7, after hardening the injection material, further including: clear-coating a surface of the IMD film.
